(19) United States
(12) Patent Application Publication
(10) Pub. No.: US 2026/0241878 A1
(43) Pub. Date: Aug. 20, 2026

(54) ELECTRONIC COMPONENT STORAGE BOX

(71) Applicant: Nissan Motor Co., Ltd., Yokohama-shi (JP)

(72) Inventor: Satoru NISHIWAKI, Kanagawa (JP)

(21) Appl. No.: 19/540,951

(22) Filed: Feb. 16, 2026

(30) Foreign Application Priority Data
Feb. 18, 2025 (JP) 2025-024252

(51) Int. Cl. B60R 16/023; H02G 3/08; H02G 3/14

(52) U.S. Cl. CPC B60R 16/0239; H02G 3/083; H02G 3/14

(57) ABSTRACT

A box body is provided in a power train room arranged in a front portion of a vehicle body. An upper cover is configured to close a top of the box body. In the box body, a notch that cuts out a wall body from a top edge downward is formed. On the upper cover, a slide cover projecting downward and to be fitted into the notch is formed. A through-hole is formed by a gap located on a lower side of the slide cover to pass a harness. The upper cover is fixed by being hooked on a fitting point provided on an upper portion of the box body.

### CROSS REFERENCE TO RELATED APPLICATIONS

This application claims priority under 35 USC 119 to Japanese Patent Application No. 2025-024252 filed on Feb. 18, 2025, the entire disclosure of Japanese Patent Application No. 2025-024252 is hereby incorporated herein by reference.

### TECHNICAL FIELD

The present invention relates to an electronic component storage box.

### BACKGROUND INFORMATION

JP 2004-64881 A discloses an electronic component storage box that is provided in a power train room and in which a through-hole is formed in a lower portion of a side surface of a box body to pass a harness. The through-hole is formed by fitting a slide cover into a notch formed by cutting out a wall body, and the slide cover is fixed to the box body by a locking means located on a lower portion of the box body.

### SUMMARY

When the locking means of the slide cover is located on the lower portion of the box body, a space where a hand can be moved is narrow and maintenance work thus becomes difficult.

A problem to be solved by the present invention is to improve work efficiency of maintenance of an electronic component storage box.

According to one aspect of the present invention, an electronic component storage box includes a box body and an upper cover. The box body is provided in a power train room arranged in a front portion of a vehicle body. The upper cover is configured to close a top of the box body. In the box body, a notch that cuts out a wall body from a top edge downward is formed. On the upper cover, a first slide cover projecting downward and to be fitted into the notch is formed. A first through-hole is formed by a gap located on a lower side of the first slide cover to pass a harness. The upper cover is fixed by being hooked on a fitting point provided on an upper portion of the box body.

According to the present invention, since a fitting point for the upper cover is provided on an upper portion of the box body and when the upper cover is removed, the first slide cover can also be removed simultaneously, work efficiency of maintenance is improved.

### BRIEF DESCRIPTION OF DRAWINGS

Referring now to the attached drawings which form a part of this original disclosure, illustrative embodiments are shown.

FIG. 1 is a diagram illustrative of a power train room;

FIG. 2 is a diagram illustrative of an electronic component storage box;

FIG. 3 is a diagram illustrative of a box body and an upper cover;

FIG. 4 is a diagram illustrative of a front structure of a vehicle body;

FIG. 5 is another diagram illustrative of the electronic component storage box;

FIGS. 6A and 6B are diagrams illustrative of fitting portions;

FIGS. 7A and 7B are diagrams illustrative of other fitting portions;

FIGS. 8A and 8B are diagrams illustrative of attachment and detachment of a slide cover;

FIGS. 9A and 9B are diagrams descriptive of strokes at the time of mounting; and

FIG. 10 is a diagram illustrative of two fitting points.

### DETAILED DESCRIPTION OF EMBODIMENTS

Embodiments of the present invention will be described below based on the drawings. Note that the respective drawings are schematic and do not necessarily depict the actual dimensions or precise configurations of practical implementation of the present invention. In addition, the following embodiments indicate a device and a method to embody the technical idea of the present invention by way of example, and the technical idea of the present invention does not limit the configuration of the constituent components to that described below. That is, the technical idea of the present invention can be subjected to a variety of alterations within the technical scope prescribed by the claims described in CLAIMS.

### Embodiment

### Configuration

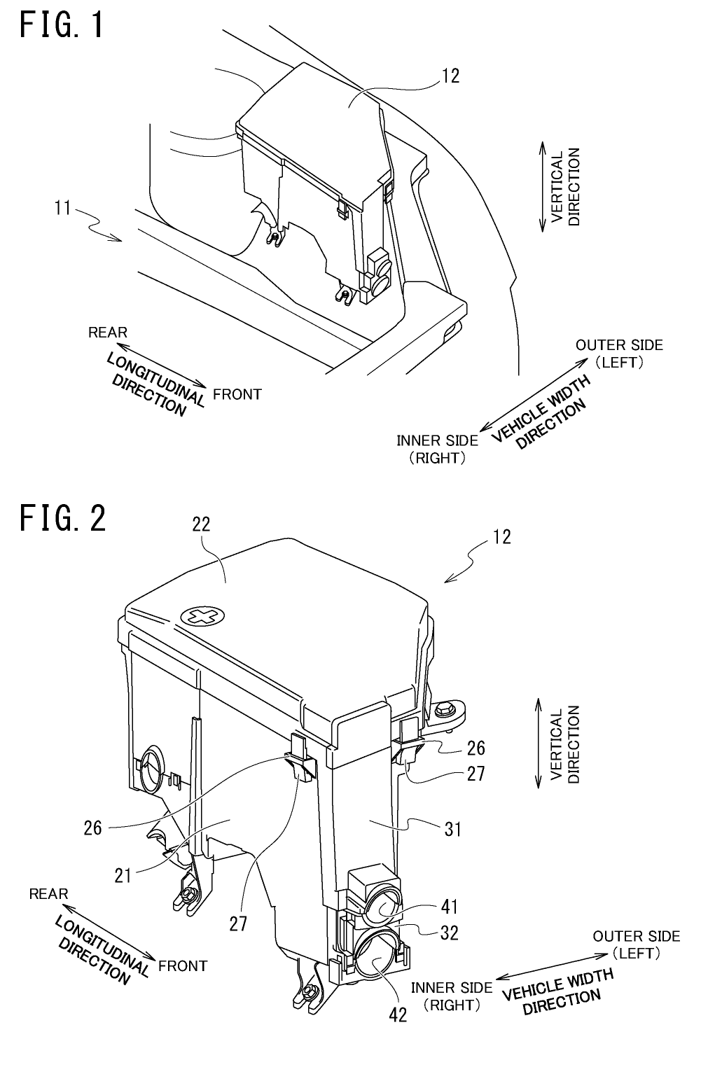

FIG. 1 is a diagram illustrative of a power train room 11.

The power train room 11 is arranged in a front portion of a vehicle body, and a drive motor or an engine is housed in the power train room 11. In the drawing, a left front area in the power train room 11 viewed from the front right upper side is illustrated. In the power train room 11, an electronic component storage box 12 is installed at a left front corner. The electronic component storage box 12 is also referred to as a physical interface unit (PIU) box, and houses an electronic control module to control a relay.

FIG. 2 is a diagram illustrative of the electronic component storage box 12.

In the drawing, the electronic component storage box 12 viewed from the front right upper side is illustrated. The electronic component storage box 12 is made of resin and includes a box body 21 and an upper cover 22. Fitting points 26 are formed on the box body 21, and clips 27 are formed on the upper cover 22. A slide cover 31 (first slide cover) is formed on the upper cover 22, and a slide cover 32 (second slide cover) is provided on the box body 21. On the electronic component storage box 12, a through-hole 41 (first through-hole) and a through-hole 42 (second through-hole) are formed.

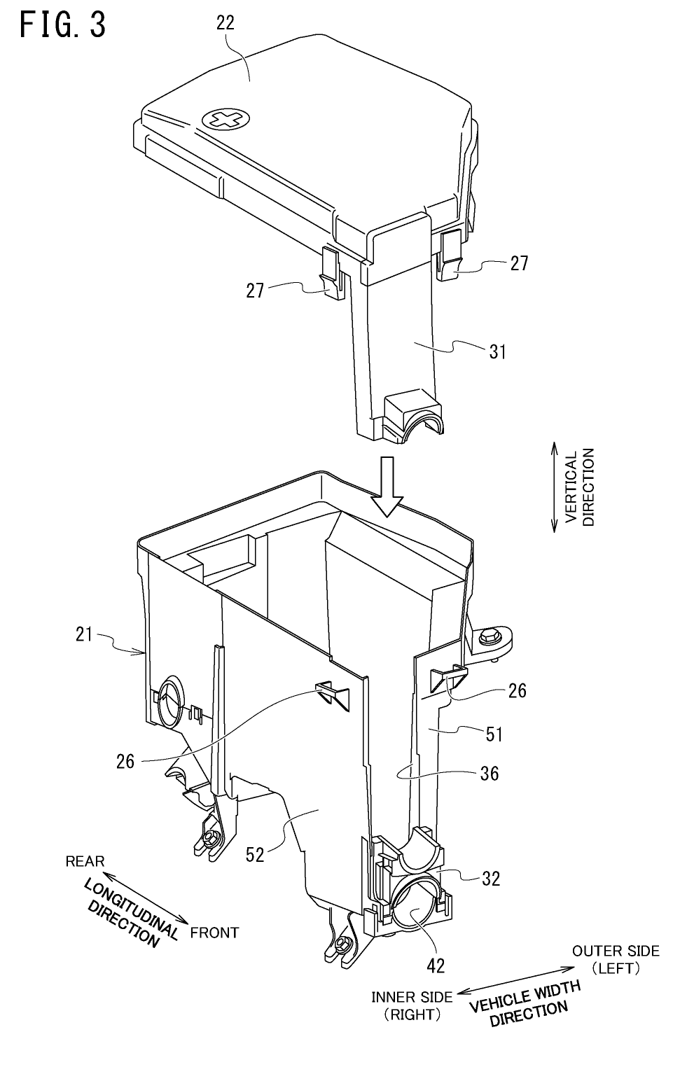

FIG. 3 is a diagram illustrative of the box body 21 and the upper cover 22.

In the drawing, the box body 21 with the upper cover 22 removed viewed from the front right upper side is illustrated. The box body 21 is formed in a container shape with a bottom and lateral sides enclosed and a top open and includes a side surface 51 (first side surface) and side surface 52 (second side surface). The side surface 51 is a flat surface that is arranged on the front side and that extends along the vertical direction and the vehicle width direction. The side surface 52 is a flat surface that is arranged on the inner side in the vehicle width direction and that extends along the vertical direction and the longitudinal direction. In a wall body constituting the side surface 51, a notch 36 that extends downward from a top edge and that cuts out the wall body to a lower portion is formed. On each of the outer side in the vehicle width direction of the notch 36 on the side surface 51 and the front portion of the side surface 52, a fitting point 26 is formed on an upper portion of an outer circumferential surface. Each fitting point 26 is formed in a substantially U-shape when viewed from above.

The upper cover 22 is a lid that is formed along the longitudinal direction and the vehicle width direction and closes the top of the box body 21. At the front edge of the upper cover 22, the slide cover 31 that projects downward and that is fitted into the notch 36 is formed. At each of the front edge and a front portion of an inner side edge in the vehicle width direction of the upper cover 22, one clip 27 is formed. Each clip 27 projects downward and is hooked on one of the fitting points 26 and fixed by a snap-fit. Note that two fitting points are also provided on a rear surface of the box body 21 and corresponding clips are formed on a rear edge of the upper cover 22, and the box body 21 and the upper cover 22 are fixed to each other at a total of four points.

A lower edge of the slide cover 31 is formed in a substantially semicircular recessed groove shape that is recessed upward when viewed from the longitudinal direction and that extends in the longitudinal direction. An upper edge of the slide cover 32 is formed in a substantially semicircular recessed groove shape that is recessed downward when viewed from the longitudinal direction and that extends in the longitudinal direction. The circular hole-shaped through-hole 41 that extends in the longitudinal direction is formed by a gap between the lower edge of the slide cover 31 and the upper edge of the slide cover 32. A lower edge of the slide cover 32 is formed in a substantially semicircular recessed groove shape that is recessed upward when viewed from the longitudinal direction and that extends in the longitudinal direction. A lower edge of the notch 36 is formed in a substantially semicircular recessed groove shape that is recessed downward when viewed from the longitudinal direction and that extends in the longitudinal direction. The circular hole-shaped through-hole 42 that extends in the longitudinal direction is formed by a gap between the lower edge of the slide cover 32 and the lower edge of the notch 36. Harnesses to be connected to the electronic control module are passed through the through-hole 41 and the through-hole 42.

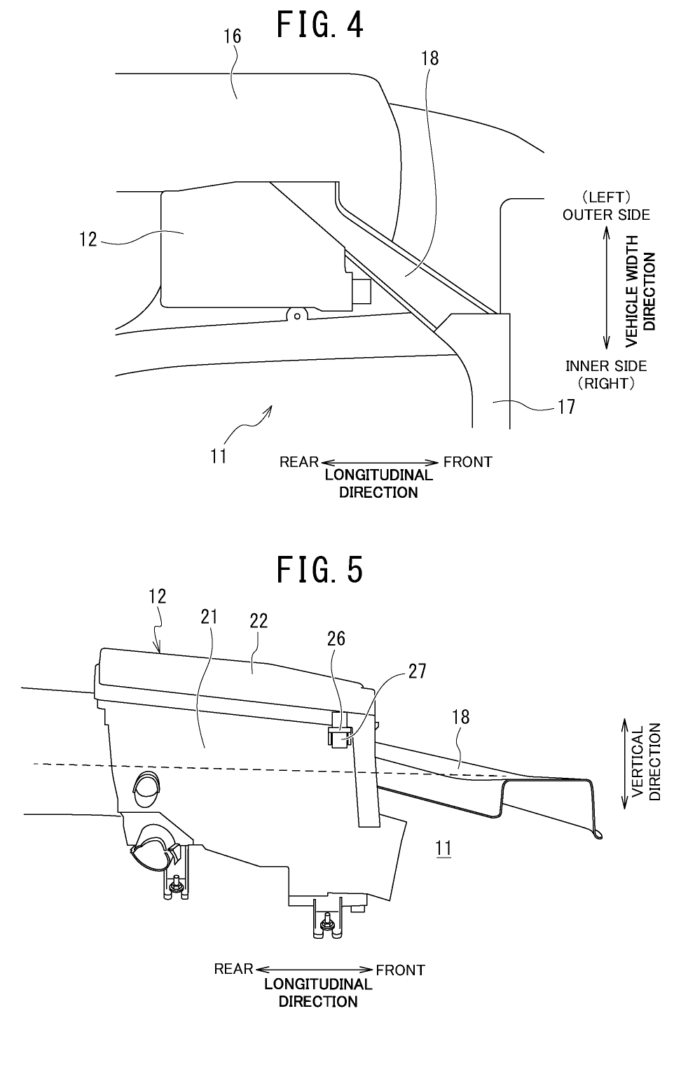

FIG. 4 is a diagram illustrative of a front structure of the vehicle body.

In the drawing, the front structure of the vehicle body viewed from above is illustrated. The front structure of the vehicle body includes a hood ridge 16, a radiator core support upper 17, and a radiator core support left 18 (skeleton members). The hood ridge 16 is a skeleton member that serves as a partition wall separating the power train room 11 from a wheel house and that extends along the longitudinal direction and the vertical direction on the outer side in the vehicle width direction. The radiator core support upper 17 is a skeleton member that extends in the vehicle width direction at an upper front portion of the vehicle body and that supports a radiator core. The radiator core support left 18 is a skeleton member that extends in a direction toward the inner side in the vehicle width direction as extending forward at the left front corner in the power train room 11 and that connects the hood ridge 16 and the radiator core support upper 17.

The electronic component storage box 12 is formed in a shape the left front corner of which is obliquely cut to avoid interference with the radiator core support left 18 when viewed from above.

FIG. 5 is another diagram illustrative of the electronic component storage box 12.

In the drawing, the electronic component storage box 12 viewed from the inner side in the vehicle width direction is illustrated. The fitting points 26 of the electronic component storage box 12 are arranged above the radiator core support left 18. Therefore, when attaching and detaching the upper cover 22 to and from the box body 21, an operator performs manipulation of the clips 27 above the radiator core support left 18.

Next, fitting portions 61 (first fitting portions) by which the notch 36 and the slide cover 31 are fitted to each other will be described.

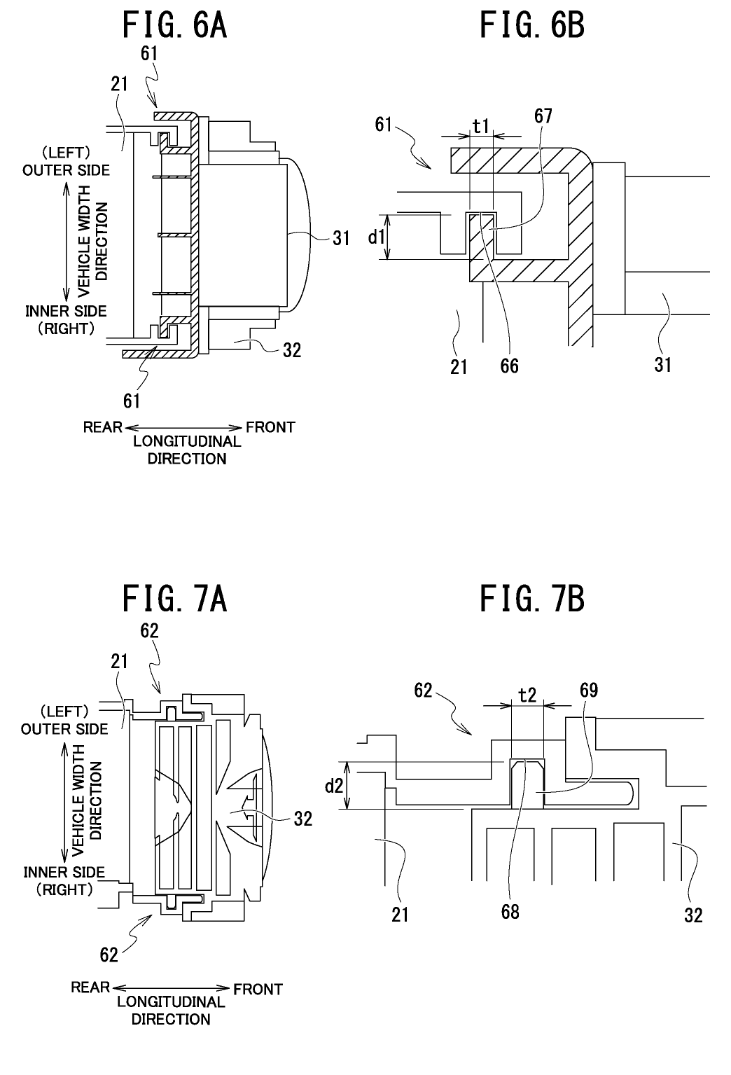

FIGS. 6A and 6B are diagrams illustrative of the fitting portions 61.

FIG. 6A illustrates the slide cover 31 fitted into the notch 36 when viewed from above. FIG. 6B illustrates one of the fitting portions 61 in an enlarged manner. The fitting portions 61 are arranged on both sides in the vehicle width direction, and each of the fitting portions 61 includes a recessed groove 66 and a protruding line 67. The recessed groove 66 is a U-shaped groove that is formed in the notch 36 of the box body 21, that extends in the vertical direction, and that is recessed toward the outer side of the through-hole 41 in the vehicle width direction when viewed from above. The protruding line 67 is a flange that is formed on the slide cover 31, that extends in the vertical direction, and that protrudes toward the outer side of the through-hole 41 in the vehicle width direction when viewed from above. A dimension of the protruding line 67 in the longitudinal direction of the vehicle body is denoted by t1, and a dimension of the protruding line 67 in the vehicle width direction of the vehicle body is denoted d1. It is assumed that although the recessed groove 66 is slightly larger than the protruding line 67, the recessed groove 66 has substantially the same dimensions as the protruding line 67. The recessed grooves 66 and the protruding lines 67 constitute a sliding structure, and by inserting the protruding lines 67 into the recessed grooves 66 from above, the slide cover 31 is fitted into the notch 36.

Next, fitting portions 62 (second fitting portions) by which the notch 36 and the slide cover 32 are fitted to each other will be described.

FIGS. 7A and 7B are diagrams illustrative of the fitting portions 62.

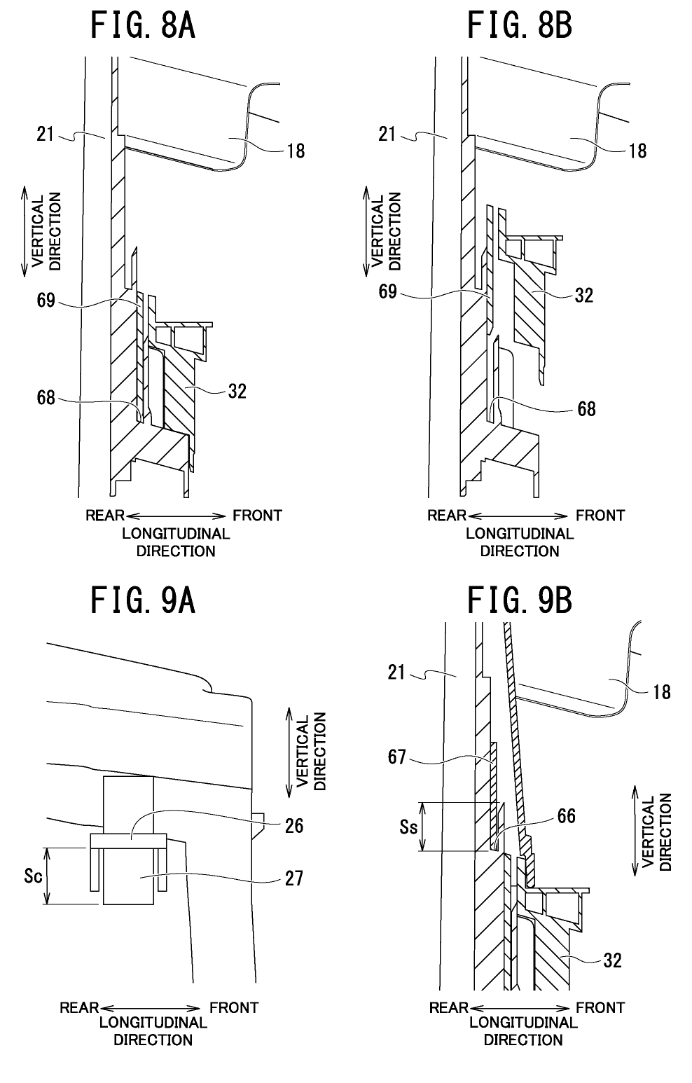

FIG. 7A illustrates the slide cover 32 fitted into the notch 36 when viewed from above. FIG. 7B illustrates one of the fitting portions 62 in an enlarged manner. The fitting portions 62 are arranged on the outer side of the fitting portions 61 in the thickness direction of the wall body, that is, on the front side of the fitting portions 61 in the vehicle body and on both sides in the vehicle width direction, and each of the fitting portions 62 includes a recessed groove 68 and a protruding line 69 (see FIGS. 8B and 9B). The recessed groove 68 is a U-shaped groove that is formed in the notch 36 of the box body 21, that extends in the vertical direction, and that is recessed toward the outer side of the through-hole 42 in the vehicle width direction when viewed from above. The protruding line 69 is a flange that is formed on the slide cover 32, that extends in the vertical direction, and that protrudes toward the outer side of the through-hole 42 in the vehicle width direction when viewed from above. A dimension of the protruding line 69 in the longitudinal direction of the vehicle body is denoted by t2, and a dimension of the protruding line 69 in the vehicle width direction of the vehicle body is denoted d2. It is assumed that although the recessed groove 68 is slightly larger than the protruding line 69, the recessed groove 68 has substantially the same dimensions as the protruding line 69. The recessed grooves 68 and protruding lines 69 constitute a sliding structure, and by inserting the protruding lines 69 into the recessed grooves 68 from above, the slide cover 32 is fitted into the notch 36.

Into the notch 36, first, the slide cover 32 is fitted, and subsequently, the slide cover 31 is fitted. In order to prevent incorrect fitting of the protruding lines 69 of the fitting portion 62 into the recessed grooves 66 of the fitting portion 61, cross-sectional areas of the fitting portions 61 and the fitting portions 62 viewed from above are differentiated. Herein, as an example, the dimension t2 of each protruding line 69 is set larger than the dimension t1 of each protruding line 67. This configuration can prevent the protruding lines 69 from being inserted into the recessed grooves 66 due to a difference in the dimensions. When the slide cover 31 is fitted into the notch 36, the slide cover 32 has already been fitted, and the recessed grooves 68 of the fitting portions 62 are closed. In addition, when the upper cover 22 is mounted on the box body 21, there is no chance that the protruding lines 67 of the slide cover 31 reach the recessed grooves 68 of the fitting portions 62. Therefore, it is not necessary to consider the incorrect fitting of the protruding lines 67 of the fitting portions 61 into the recessed grooves 68 of the fitting portions 62.

FIGS. 8A and 8B are diagrams illustrative of attachment and detachment of the slide cover 32.

FIG. 8A illustrates a cross section of the slide cover 32 lowered to a mounting position that passes a protruding line 69 and that extends along the vertical direction and the longitudinal direction when viewed from the inner side in the vehicle width direction. Above the slide cover 32, the radiator core support left 18 exists. FIG. 8B illustrates a cross section of the slide cover 32 raised to a removal position that passes the protruding line 69 and that extends along the vertical direction and the longitudinal direction when viewed from the inner side in the vehicle width direction. Even the slide cover 32 is raised to the removal position, there is still room in the vertical direction with respect to the radiator core support left 18, and a sufficient work space is secured.

FIGS. 9A and 9B are diagrams descriptive of strokes at the time of mounting.

FIG. 9A illustrates the fitting point 26 and the clip 27 on the side surface 52 viewed from the inner side in the vehicle width direction. A stroke amount Sc when the clip 27 is fitted into the fitting point 26 is equivalent to a dimension from the lower end of the clip 27 to a stepped surface hooked on the fitting point 26. FIG. 9B illustrates a cross section of the slide cover 31 after being mounted that passes a protruding line 67 and that extends along the vertical direction and the longitudinal direction when viewed from the inner side in the vehicle width direction. A stroke amount Ss when the slide cover 31 is fitted into the notch 36 is equivalent to length in the vertical direction of a recessed groove 66. The stroke amount Sc when the clip 27 is fitted into the fitting point 26 is set larger than the stroke amount Ss when the slide cover 31 is fitted into the notch 36. Since the stroke ends of both strokes are substantially identical, when the upper cover 22 is mounted, first, the clip 27 begins to be fitted into the fitting point 26, and subsequently, the protruding line 67 begins to be fitted into the recessed groove 66.

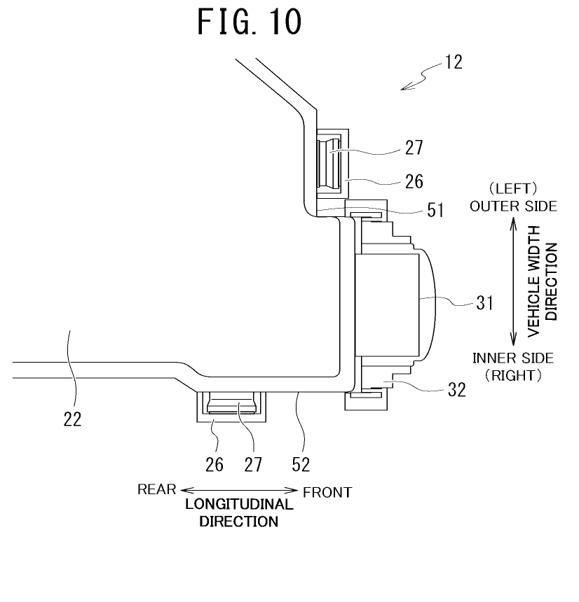

FIG. 10 is a diagram illustrative of two fitting points 26.

In the drawing, the two fitting points 26 viewed from above are illustrated. A fitting point 26 is formed on each of the side surface 51 and the side surface 52. The side surface 51 and the side surface 52 are adjacent to each other, are substantially orthogonal to each other when viewed from above, and form a right front corner of the electronic component storage box 12. On the side surface 51, the slide cover 31 is arranged on the innermost side in the vehicle width direction, and the fitting point 26 is arranged at a position closest to the slide cover 31 on the outer side in the vehicle width direction of the slide cover 31. On the side surface 52, the fitting point 26 is arranged on the front side in the longitudinal direction. As described above, the two fitting points 26 are arranged around the right front corner of the electronic component storage box 12.

### Advantageous Effect

Next, main advantageous effects of the embodiment will be described.

(1) An electronic component storage box 12 includes a box body 21 and an upper cover 22. The box body 21 is provided in a power train room 11 arranged in a front portion of a vehicle body. The upper cover 22 is configured to close a top of the box body 21. In the box body 21, a notch 36 that cuts out a wall body from a top edge downward is formed. On the upper cover 22, a slide cover 31 projecting downward and to be fitted into the notch 36 is formed. A through-hole 41 is formed by a gap located on a lower side of the slide cover 31 to pass a harness. The upper cover 22 is fixed by being hooked on a fitting point 26 provided on an upper portion of the box body 21. Since on the upper portion of the box body 21, the fitting point 26 for the upper cover 22 is provided and when the upper cover 22 is removed, the slide cover 31 can also be removed simultaneously, work efficiency of maintenance is improved. Since the slide cover 31 is fitted by a sliding structure, an operator is not required to extend his/her arm to a lower portion, and work efficiency is thus improved.

(2) The box body 21 is arranged at a corner on a front side and an outer side in a vehicle width direction in the power train room 11 and has the fitting point 26 arranged above a radiator core support left 18 located on an upper side in the corner. Because of this configuration, the operator can visually recognize the fitting point 26, and attachment and detachment of the upper cover 22 is facilitated.

(3) The electronic component storage box 12 includes a slide cover 32. The slide cover 32 is fitted into the notch 36 below the slide cover 31. To pass a harness, the through-hole 41 is formed by a gap between the slide cover 31 and the slide cover 32 and a through-hole 42 is formed by a gap located on a lower side of the slide cover 32. Arrangement positions viewed from above of a fitting portion 61 by which the notch 36 and the slide cover 31 are fitted to each other and a fitting portion 62 by which the notch 36 and the slide cover 32 are fitted to each other are different from each other in a thickness direction of a wall body. This configuration can prevent a situation where a stroke amount of the sliding structure becomes long more than necessary in the fitting portion 62 and work efficiency deteriorates. That is, when the fitting portion 62 is located on an extension line of the fitting portion 61, the slide cover 32 is required to be moved to the fitting portion 62 after passing the fitting portion 61, and work efficiency deteriorates due to an additional stroke amount in the fitting portion 61.

(4) The fitting portion 62 is arranged on an outer side of the fitting portion 61 in a thickness direction of a wall body. Because of this configuration, it becomes easier for the operator to visually recognize the fitting portion 62, and work efficiency is improved. That is, in the narrow power train room 11, the lower a part of the electronic component storage box 12 is located, the dimmer a shadowed space around the part becomes. Therefore, in a configuration in which the fitting portion 62 is arranged further on the inner side of the fitting portion 61 in the thickness direction of the wall body, the fitting portion 62 becomes more difficult to visually recognize.

(5) The fitting portion 61 and the fitting portion 62 have different cross-sectional areas viewed from above. This configuration can prevent incorrect fitting of the slide cover 32, which has to be fitted into the fitting portion 62, into the fitting portion 61.

(6) On the upper cover 22, a clip 27 to be fitted into the fitting point 26 is formed. A stroke amount Sc when the clip 27 is fitted into the fitting point 26 is larger than a stroke amount Ss when the slide cover 31 is fitted into the notch 36. Because of this configuration, when the upper cover 22 is mounted, first, the clip 27 begins to be fitted into the fitting point 26, and subsequently, a protruding line 67 begins to be fitted into a recessed groove 66. Therefore, since positioning is first performed by the fitting point 26 and the clip 27, precise positioning is not required in the fitting portion 61 where the notch 36 and the slide cover 31 are fitted to each other, and work efficiency is thus improved.

(7) The box body 21 includes a side surface 51 and a side surface 52. The side surface 51 has the through-hole 41 formed. The side surface 52 faces a different direction from the side surface 51 when viewed from above. In other words, the side surface 52 is formed not by a surface parallel to the side surface 51 but by a surface not parallel to the side surface 51 when viewed from above. On the upper cover 22, the fitting points 26 are formed on at least both the side surface 51 and the side surface 52. Because of this configuration, positioning in two directions can be performed when viewed from above, and work efficiency is improved.

### Variation

Although in the embodiment, the dimension t2 of the protruding lines 69 is set larger than the dimension t1 of the protruding lines 67 in the fitting portions 61 and the fitting portions 62, the present invention is not limited thereto. That is, the dimension d2 of the protruding lines 69 may be made larger than the dimension d1 of the protruding lines 67, or one of the fitting portions 61 and the fitting portions 62 may be formed in a substantially L-shape when viewed from above. Differentiating various types of dimensions and shapes in this way enables incorrect assembly of the slide cover 32 to be prevented. Therefore, it is only necessary that the protruding lines 69 and the protruding lines 67 have different cross-sectional area when viewed from above.

While the present invention has been described herein referring to a limited number of embodiments, the scope of the present invention is not limited to the embodiments, and modifications and variations of the embodiments based on the above-described disclosure are apparent to a person skilled in the art.

What is claimed is:

1. An electronic component storage box comprising:
a box body provided in a power train room arranged in a front portion of a vehicle body; and
an upper cover configured to close a top of the box body,
wherein in the box body, a notch that cuts out a wall body from a top edge downward is formed,
on the upper cover, a first slide cover projecting downward and to be fitted into the notch is formed,
a first through-hole is formed by a gap located on a lower side of the first slide cover to pass a harness, and
the upper cover is fixed by being hooked on a fitting point provided on an upper portion of the box body.

2. The electronic component storage box according to claim 1, wherein
the box body is arranged at a corner on a front side and an outer side in a vehicle width direction in the power train room and has the fitting point arranged above a skeleton member located on an upper side in the corner.

3. The electronic component storage box according to claim 1, further comprising
a second slide cover fitted into the notch below the first slide cover,
wherein to pass a harness, the first through-hole is formed by a gap between the first slide cover and the second slide cover and a second through-hole is formed by a gap located on a lower side of the second slide cover, and
arrangement positions viewed from above of a first fitting portion by which the notch and the first slide cover are fitted to each other and a second fitting portion by which the notch and the second slide cover are fitted to each other are different from each other in a thickness direction of a wall body.

4. The electronic component storage box according to claim 3, wherein
the second fitting portion is arranged on an outer side of the first fitting portion in a thickness direction of a wall body.

5. The electronic component storage box according to claim 3, wherein
the first fitting portion and the second fitting portion have different cross-sectional areas viewed from above.

6. The electronic component storage box according to claim 1, wherein
on the upper cover, a clip to be fitted into the fitting point is formed, and
a stroke amount when the clip is fitted into the fitting point is larger than a stroke amount when the first slide cover is fitted into the notch.

7. The electronic component storage box according to claim 1, wherein
the box body includes
a first side surface in which the first through-hole is formed; and
a second side surface facing a different direction from the first side surface when viewed from above, and
on the upper cover, the fitting points are formed on at least both the first side surface and the second side surface.
